(19) United States
(12) Patent Application Publication
(10) Pub. No.: US 2009/0098886 A1
(43) Pub. Date: Apr. 16, 2009

(54) SYSTEM AND METHOD FOR PROVIDING PRESENCE NOTIFICATIONS BASED UPON WATCHER STATUS

(75) Inventors: Krisztian Kiss, San Francisco, CA (US); Miraj Mostafa, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/248,846

(22) Filed: Oct. 9, 2008

Related U.S. Application Data
(60) Provisional application No. 60/980,342, filed on Oct. 16, 2007.

(51) Int. Cl. H04W 4/02

(52) U.S. Cl. 455/456.1

(57) ABSTRACT

A system and method for providing Presence notifications based upon a user's status. According to various embodiments, a Watcher can provide an indication of filtering criteria for incoming Presence information. A network agent can be used to filter 5 unnecessary notifications before they reach the Watcher. Presence notifications can be sent or not sent to a Watcher at certain times based upon the Watcher's availability and/or willingness to receive such notifications. These arrangements optimize Presence traffic by not sending Presence information over a costly radio interface at times when the information would not be useful to the intended recipient of the information.

### CROSS-REFERENCE TO RELATED PATENT APPLICATIONS

This application claims priority from Provisional Application U.S. Application 60/980342, filed Oct. 16, 2007, incorporated herein by reference in its entirety.

### FIELD OF THE INVENTION

The present invention relates generally to Presence Services. More particularly, the present invention relates to the communication of Presence information among a Presence Source, a Presence Server and a Watcher.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A Presence Service is a network service which accepts, stores and distributes Presence information. Presence information typically comprises a status indicator that indicates the ability and willingness of a communication partner to communicate.

Presence Service can be linked with many other services or enablers. “Horizontal” Presence Services can be used as the launching pad for a different type of communication. Moreover, Horizontal Presence Services can be used to circulate personal and device-specific information to a selected set of authorized Watchers. (A Watcher or Presence information Watcher is an entity that requests Presence information about a Presentity (an entity described by Presence information) from a Presence Service.) However, all of these services can collectively cause a great deal of Presence traffic.

Due to the nature of Presence Services, a simple change in one's Presence information can cause a significant amount of traffic in a network. Additionally, the integration of location information within a Presence Service can be quite demanding in terms of traffic. For example, it is helpful to consider a situation where an entity uploads its location information whenever this information changes. In this situation, if the location of the entity is regularly changing, then a great deal of network traffic is generated.

In light of the traffic-related issues of the type discussed above in terms of Presence systems, there have been several efforts to optimize traffic flow as far as Presence information is concerned. However, it is still desirable to further reduce the amount of Presence-related traffic.

### SUMMARY OF THE INVENTION

Various embodiments of the present invention provide an improved system and method for providing Presence notifications based upon a user's status. A Watcher is capable of specifying one or more conditions upon which Presence notifications are generated and sent to the Watcher. More particularly, in various embodiments, a Watcher can provide an indication of filtering criteria for incoming Presence information. A network agent can be used to filter unnecessary notifications before they reach the Watcher. As a consequence, Presence notifications can be sent or not sent to a Watcher at certain times based upon the Watcher's availability. In these various embodiments, a condition is provided by the Watcher to indicate whether Presence notifications should be suppressed depending upon particular Watcher Presence state values. These arrangements therefore serve to further optimize Presence traffic by not sending Presence information over a costly radio interface at times when the information simply would not be useful to the intended recipient of the information.

Various embodiments of the present invention are applicable for virtually any Presence solution, including Internet Messaging and Presence Services (IMPS) (defined by the Open Mobile Alliance (OMA)), Session Initiation Protocol (SIP) Instant Message and Presence Leveraging Extensions (SIMPLE) Presence (also defined by the OMA) and the Extensible Messaging and Presence Protocol (XMPP) (defined by the Internet Engineering Task Force (IETF)).

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flowchart showing how the event notification filtering framework can be extended so as to selectively prevent Presence information from being sent to a Watcher based upon the Watcher's unavailability and/or unwillingness to receive the Presence information;

FIG. 2 is a flowchart showing how a network agent or Watcher Agent can be used to selectively prevent Presence information from being sent to a Watcher based upon the Watcher's unavailability and/or unwillingness to receive the Presence information;

FIG. 3 is a perspective view of an electronic device that can be used in conjunction with the implementation of various embodiments of the present invention; and

FIG. 4 is a schematic representation of the circuitry which may be included in the electronic device of FIG. 4.

### DETAILED DESCRIPTION OF VARIOUS EMBODIMENTS

Various embodiments of the present invention provide an improved system and method for providing Presence notifications based upon a user's status. A Watcher is capable of specifying one or more conditions upon which Presence notifications are generated and sent to the Watcher. More particularly, in various embodiments, a Watcher can provide an indication of filtering criteria for incoming Presence information. A network agent can be used to filter unnecessary notifications before they reach the Watcher. As a consequence, Presence notifications can be sent or not sent to a Watcher at certain times based upon the Watcher's availability. In these various embodiments, a condition is provided by the Watcher to indicate whether Presence notifications should be suppressed depending upon particular Watcher Presence state values. These arrangements therefore serve to further optimize Presence traffic by not sending Presence information over a costly radio interface at times when the information simply would not be useful to the intended recipient of the information.

Once subscribed, the notifications intended for the Watcher arrive regardless of the Watcher's own individual status. For example, a Watcher can subscribe for the Presence information of her friends for a period of a day. During this day, she may spend some time (e.g., a couple of hours) in a meeting at work. In the afternoon/evening, she may have an activity such as tennis for a couple of hours, and the Watcher may have other attention-occupying activities as well during the day. During these times, the Watcher is busy and (1) is not likely to be communicating with her friends and/or (2) is not likely to even be interested in the new status of her friends. Therefore, during these “busy” periods, the Watcher really does not care about the Presence information of her friends, as she is not even in a position to use the new Presence information when she is busy. However, in conventional arrangements, the Watcher's device continues to receive updates to her friends' Presence information during these busy periods. As a result, the Watcher may have to pay for the unnecessary updating of her friends' Presence information, causing a more unpleasant user experience. This in turn may adversely impact the Watcher's operator or service provider, as the user may not remain interested in the Presence service if she is forced to continue to pay for updates during periods where she has no use for the information. Although a Watcher could avoid reducing the amount of Presence information traffic during busy periods by turning off the Watcher's device, this is not an optimal solution to the problem, in part because the Watcher may want to keep the device turned on for various reasons.

As a manner of addressing the situation depicted above, various embodiments provide a mechanism for controlling notifications of the Presence information so that such notifications are sent only when they can be consumed by the Recipient. According to various embodiments, a Watcher can provide an indication of filtering criteria for incoming Presence information. A network agent can be used to filter unnecessary notifications before they reach the Watcher. As a consequence, Presence notifications can be sent or not sent to a Watcher at certain times based upon the Watcher's availability. These arrangements therefore serve to further optimize Presence traffic by not sending Presence information over a costly radio interface at times when the information simply would not be useful to the intended recipient of the information. In these embodiments, the Watcher does not receive any Presence updates when she is unavailable, even if there are any changes in the Presence information of any Presentities of interest. The presence information can instead be updated immediately upon the Watcher changing her state back to being available and/or willing to receive updates.

Many of the following show sample implementations of various embodiments of the present invention in a SIMPLE presence environment. However, one skilled in the art would understand that various embodiments of the present invention are applicable to other Presence solutions as well.

In certain embodiments of the invention, the scope of the event notification filtering framework is extended. In a conventional SIP/SIMPLE Presence system, a Watcher can indicate the filtering criteria of incoming Presence information. This ability is discussed, for example, in IETF's Request for Comments (RFC) 4660, entitled “Functional Description of Event Notification Filtering,” and 4661, entitled “An Extensible Markup Language (XML)-Based Format for Event Notification Filtering.” These documents can be found at www.ietf.org/rfc/rfc4660.txt?number=4660 and www.ietf.org/rfc/rfc4661.txt?number=4661, respectively. In the conventional event notification filtering arrangements, the filtering criteria are based solely on the Presence information of the Presentity.

In various embodiments, the scope of event notification filtering is extended to cover not only the Presence information of the Presentity, but also the Presence information of the Watcher. In this arrangement, Presence notifications are sent to the Watcher depending on the Presence information of the Watcher. More specifically, a particular Presence notification is only sent to the Watcher when the Watcher is available and/or willing to communicate. In this arrangement, a user (i.e., a Watcher in this case) can indicate in her Presence information subscription that she is not willing to receive any communication when she is busy (e.g., when in a meeting or involved in another activity). Therefore, in various embodiments the availability of the Watcher becomes a filtering criterion, in which case Presence information regarding the Watcher's friends is sent to the Watcher's device only when she is available and/or willing to communicate.

In particular embodiments, user “availability” and “willingness” of the Watcher to receive Presence information comprise two possible filtering criteria for receiving Presence information. However, these criteria may be modified and/or additional criteria could be used by the Watcher to decide if and when Presence information should be received, and corresponding values that stop and/or start incoming Presence notifications could be set by a user in various embodiments.

As mentioned previously, the existing event notification filter is described in terms of the XML schema in IETF RFC 4661, and the schema is extensible. In particular, Section 4 of IETF RFC 4661 describes how to extend the schema. Therefore, the event notification filtering discussed herein can be mapped to new XML elements and attributes, thereby extending the existing XML schema with the new necessary XML items in a compatible and consistent manner.

The existing XML schema currently includes a <trigger> element in order to indicate when content (i.e., a notification in a Presence situation) should be sent. More particularly, the element can indicate any change in the package (i.e., a Presence Document in this case) that should cause a new notification to be sent. Conventionally, this element has referred to the published Presence Document of the subscribed Presentity. In various embodiments described herein, however, the published Presence Document of the Watcher is also covered. In this context, the XML schema points to a different Presence Document. Other elements in the schema (e.g., <changed>, <from> and <to>) are used to indicate the desired modifications in the Watcher Presence Document which will cause a new notification to be transmitted. Pointing to a different Presence Document, namely the Presence Document of the Watcher, can be achieved with a uniform resource identifier (URI). For this reason, a new attribute “uri” can be defined for the <trigger> element, and the value of the attribute can comprise the URI for the Presence Document of the Watcher. It should be noted, however, that the “uri” attribute is but one example way to point to the Presence Document of a Watcher or other device, and one skilled in the art would readily understand that other systems may be used to point to a different Presence Document.

In many situations, a Watcher and a Presentity share the same Presence Server. In this situation, it is not difficult for the Presentity's Presence Server to locate the Watcher's Presence Document. In case of a resource list server (RLS) subscription, the notifications are aggregated locally. When the RLS and the Presence Server are combined in an implementation, the Presentity's Presence Server can also easily locate the Watcher's Presence Document, even if the subscription is performed via the RLS. In order to handle the case where the Watcher's Presence Document and the Presentity's Presence Document exist in different operator domains, the Watcher's Presence Server has to be contacted by the Presentity's Presence Server in order to determine the Watcher's Presence status.

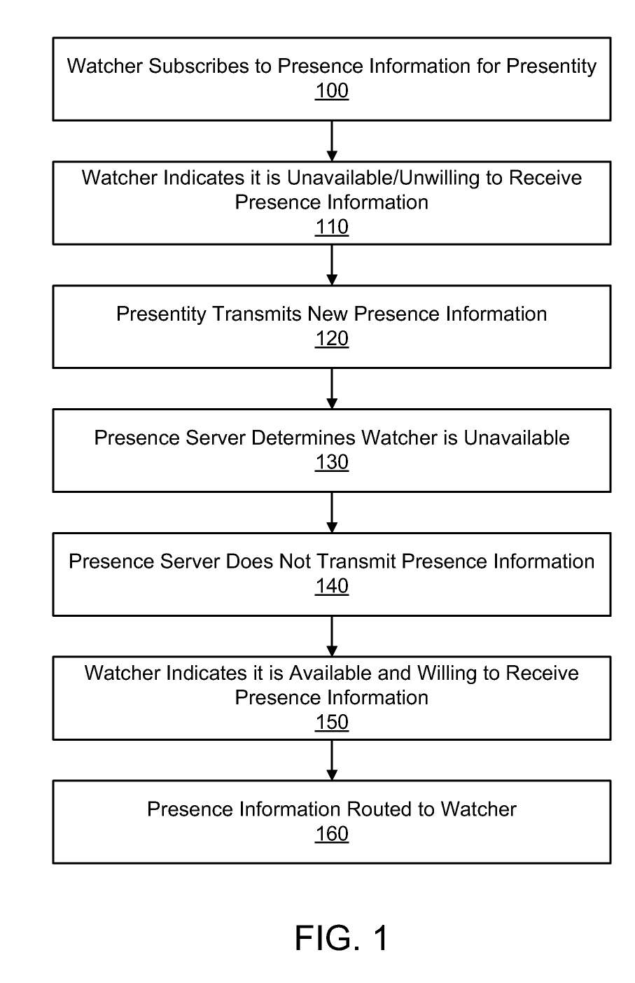

FIG. 1 is a flowchart showing how to selectively prevent Presence information from being sent to a Watcher based upon the Watcher's unavailability and/or unwillingness to receive the Presence information. At 100 in FIG. 1, a Watcher device subscribes for Presence information of a Presentity. The Watcher also indicates to only receive notifications when the Watcher is available and/or willing to communicate. At 110, the Watcher alters its Presence information, indicating that the Watcher is unavailable and/or unwilling to receive Presence information. This is accomplished through the Watcher's Presence Document being modified. At some later point in time and at 120, the Presentity changes Presence information about itself. If the Presentity and the Watcher both share the same Presence Server this change will be transmitted to the Watcher's and Presentity's Presence Server. In the case of an RLS subscription, the transmission will traverse the Watcher's RLS, which may be implemented together with the Presence Server. At 130, the Presentity's Presence Server checks the Watcher's Presence Document and notes that the Watcher is unavailable and/or unwilling to receive the Presence information. In response to this determination, the Presentity's Presence Server decides not to transmit the Presence information to the Watcher at 140. At 150, the Watcher later indicates that it is available and willing to receive Presence information from the Presentity. Once this indication has been made, future transmissions of Presence information can be routed to the Watcher at 160.

In other embodiments of the present invention, a network agent is used to filter unnecessary notifications. Alternatively still, a “Watcher Agent” can be placed in the Watcher's home network to act on behalf of the Watcher. In these situations, all subscriptions and notifications that are initiated by the Watcher are transmitted via this agent (i.e., the agent is a Record-Routing SIP proxy). The agent also monitoring the Watcher's Presence status by subscribing to the Watcher's presence information. When the agent detects the Watcher's Presence status to be unavailable, it simply consumes the notifications that were targeted towards the Watcher. The agent then resumes sending the notifications when the Watcher once again becomes available.

The Watcher Agent can be implemented as an application server, which may act as a Record-Routing SIP proxy or an SIP User Agent. In various embodiments, the Watcher Agent is located in the Watcher's home network, where the Watcher's presence information is local knowledge. More particularly, the Watcher Agent may be part of the Watcher's Presence Server as a functional entity, in which case no extra subscription is needed for the Watcher's presence information. In the case where the Watcher and the Presentity share the same Presence Server, the entirety of the necessary processing becomes internal to the Presence Server.

The Watcher Agent acts on behalf of the Watcher. If the Watcher Agent is implemented in a standalone Application Server, it has to Record-Route SUBSCRIBE requests initiated by the Watcher and targeted to the Watcher's Presence Server. In the 3GPP IP Multimedia Subsystem (IMS) environment, this means that the initial filter criteria for the SUBSCRIBE request with the Event:Presence header field has to first point to this Application Server before reaching the Presence Server. The Record-Routing ensures that mid-dialog NOTIFY requests traverse the Watcher Agent based upon the conditions indicated by the Watcher upon which NOTIFY requests should be generated.

The Watcher Agent continuously monitors the Watcher's Presence information by subscribing to the Watcher's presence. When the Watcher Agent detects the Watcher's presence status to be “unavailable” or the like, the Watcher Agent terminates the notifications addressed to the Watcher. In an alternative embodiment, the Watcher Agent can retarget the NOTIFY requests to a storage server when the Watcher's Presence status is “unavailable” or the like. In this arrangement, the Watcher can later download the history of the Presence changes that occurred when the Watcher was unavailable. In either scenario, when the Watcher Agent detects that the Watcher's Presence status has been changed to “available” or the like, the Watcher Agent resumes sending the notifications to the Watcher by simply proxying the NOTIFY requests forward.

In either of the above scenarios, previously-standardized procedures can be used without having to implement any changes to the behavior of either the Watcher or Presence Server. Instead, the only modifications that are necessary involve adjusting the internal logic of the Watcher Agent so as to detect the Watcher's availability and willingness, as well as to act on the traversing NOTIFY requests accordingly.

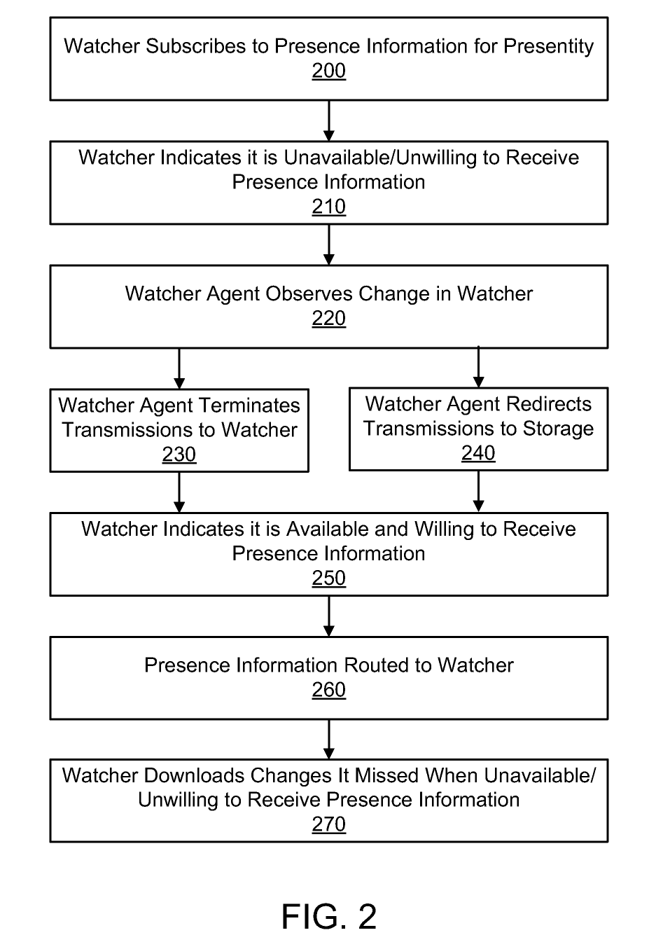

FIG. 2 is a flowchart showing how a network agent or Watcher Agent can be used to selectively prevent Presence information from being sent to a Watcher based upon the Watcher's unavailability and/or unwillingness to receive the Presence information. At 200 in FIG. 2, a Watcher device subscribes for Presence information of a Presentity. The Watcher also indicates to only receive notifications when the Watcher is available and/or willing to communicate. At 210, the Watcher alters its Presence information, indicating that the Watcher is unavailable and/or unwilling to receive Presence information. At 220, a Watcher Agent, which monitors the Presence information for the Watcher, observes the latest change in the Watcher's Presence information. In response to this detection, at 230 the Watcher Agent terminates the transmissions of the Presentity's Presence Information notifications intended for the Watcher. Alternatively to the process described at 230, the Watcher Agent may redirect the Presentity's Presence information notifications to a storage server at 240. In either event, in response to the Watcher later indicating that it is available and willing to receive Presence information from the Presentity (represented at 250), subsequent transmissions of Presence information are again routed to the Watcher at 260 by having the Watcher Agent proxy the information forward. In the case where “interrupted” notifications were sent to a storage server, at 270 the Watcher can also download the changes to the Presentity's Presence information which it did not receive when it was unavailable and/or unwilling to receive them.

Communication devices of the various embodiments discussed herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802. 11, etc. A communication device may communicate using various media including, but not limited to, radio, infrared, laser, cable connection, and the like.

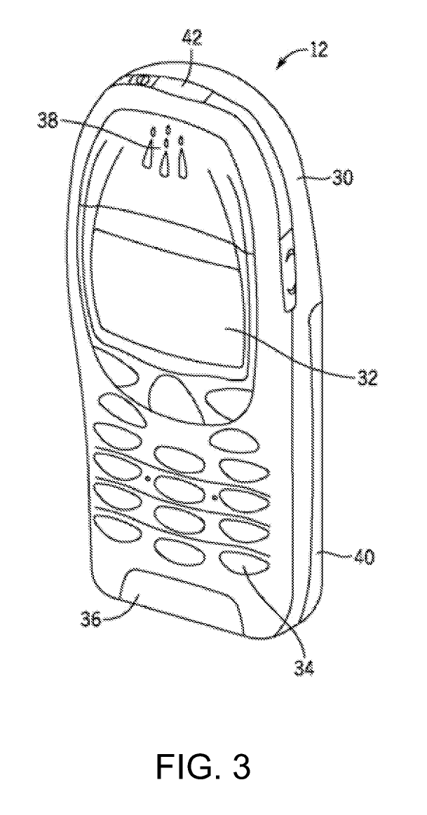

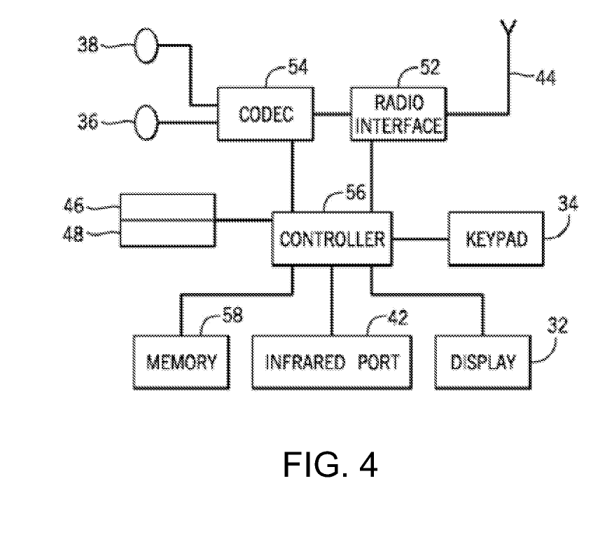

FIGS. 3 and 4 show one representative mobile device 12 within which various embodiments may be implemented. Any and all of the devices described herein may include any and/or all of the features described in FIGS. 3 and 4. It should be understood, however, that the present invention is not intended to be limited to one particular type of electronic device. The mobile device 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
executing a subscription to receive Presence information notifications at a Watcher device from a remote device; and
altering the subscription so as not to receive any Presence information notifications at the Watcher device due to the Watcher device being at least one of unavailable to receive the Presence information and unwilling to receive the Presence information;
wherein, in response to the altered subscription, all Presence information notifications are prevented from being received by the Watcher device.

2. The method of claim 1, wherein a Watcher agent is used to prevent all Presence information notifications from being received by the Watcher device in response to the altered subscription.

3. The method of claim 2, wherein the Watcher agent is implemented as a stand alone application server within a home network of the Watcher device.

4. The method of claim 2, wherein the Watcher agent is implemented as part of a Presence server for the Watcher device.

5. The method of claim 1, wherein a Presence server of a Presentity is used to prevent all Presence information notifications from being received by the Watcher device in response to the altered subscription, and wherein the Presence server determines that whether individual Presence information notifications should be received by the Watcher device by reviewing a published Presence document for the Watcher device.

6. The method of claim 1, wherein the altering of the subscription comprises using filtering criteria based upon at least one of availability and willingness to receive any Presence information notifications at the Watcher device.

7. A computer program product, embodied in a computer-readable medium, comprising computer code configured to perform the processes of claim 1.

8. An apparatus, comprising:
a processor; and
a memory unit communicatively connected to the processor and including:
computer code configured to execute a subscription to receive Presence information notifications at a Watcher device from a remote device; and
computer code configured to alter the subscription so as not to receive any Presence information notifications at the Watcher device due to the Watcher device being at least one of unavailable to receive the Presence information and unwilling to receive the Presence information;
wherein, in response to the altered subscription, all Presence information notifications are prevented from being received by the Watcher device.

9. The apparatus of claim 8, wherein a Watcher agent is used to prevent all Presence information notifications from being received by the Watcher device in response to the altered subscription.

10. The apparatus of claim 9, wherein the Watcher agent is implemented as a stand alone application server within a home network of the Watcher device.

11. The apparatus of claim 9, wherein the Watcher agent is implemented as part of a Presence server for the Watcher device.

12. The apparatus of claim 8, wherein a Presence server of a Presentity is used to prevent all Presence information notifications from being received by the Watcher device in response to the altered subscription, and wherein the Presence server determines that whether individual Presence information notifications should be received by the Watcher device by reviewing a published Presence document for the Watcher device.

13. The apparatus of claim 8, further comprising computer code for downloading from a storage server the Presence information notifications that were not received by the Watcher device when the Presence information notifications were prevented from being received by the Watcher device.

14. The apparatus of claim 8, wherein the altering of the subscription comprises using filtering criteria based upon at least one of availability and willingness to receive any Presence information notifications at the Watcher device.

15. A method, comprising:
determining that a device is attempting to transmit a Presence information notification to a Watcher device;
determining a Presence status of the Watcher device; and
in response to a determination that the Watcher device's Presence status is set such that the Watcher device is not to receive any Presence information notifications at the Watcher device due to the Watcher device being at least one of unavailable to receive the Presence information and unwilling to receive the Presence information, using a network entity to prevent any Presence information notifications from reaching the Watcher device.

16. The method of claim 15, wherein the network entity comprises a Watcher agent.

17. The method of claim 16, wherein the Watcher agent is implemented as a stand alone application server within a home network of the Watcher device.

18. The method of claim 16, wherein the Watcher agent is implemented as part of a Presence server for the Watcher device.

19. The method of claim 15, wherein the Watcher device's Presence status is checked using filtering criteria based upon at least one of availability and willingness to receive any Presence information notifications at the Watcher device.

20. A computer program product, embodied in a computer-readable medium, comprising computer code configured to perform the processes of claim 15.

21. An apparatus, comprising:
a processor; and
a memory unit communicatively connected to the processor and including:
computer code configured to determine that a device is attempting to transmit a Presence information notification to a Watcher device;
computer code configured to determine a status of the Watcher device; and
computer code configured to, in response to a determination that the Watcher device's Presence status is set such that the Watcher device is not to receive any Presence information notifications at the Watcher device due to the Watcher device being at least one of unavailable to receive the Presence information and unwilling to receive the Presence information, prevent any Presence information notifications from reaching the Watcher device.

22. The apparatus of claim 21, wherein the apparatus comprises a Watcher agent.

23. The apparatus of claim 22, wherein the Watcher agent is implemented as a stand alone application server within a home network of the Watcher device.

24. The apparatus of claim 22, wherein the Watcher agent is implemented as part of a Presence server for the Watcher device.

25. The apparatus of claim 21, wherein the Watcher device's Presence status is checked using filtering criteria based upon at least one of availability and willingness to receive any Presence information notifications at the Watcher device

26. An apparatus, comprising:
means for executing a subscription to receive Presence information notifications at a Watcher device from a remote device; and
means for altering the subscription so as not to receive any Presence information notifications at the Watcher device due to the Watcher device being at least one of unavailable to receive the Presence information and unwilling to receive the Presence information;
wherein, in response to the altered subscription, all Presence information notifications are prevented from being received by the Watcher device.

27. An apparatus, comprising:
means for determining that a device is attempting to transmit a Presence information notification to a Watcher device;
means for determining a status of the Watcher device; and
means for, in response to a determination that the Watcher device's Presence status is set such that the Watcher device is not to receive any Presence information notifications at the Watcher device due to the Watcher device being at least one of unavailable to receive the Presence information and unwilling to receive the Presence information, preventing any Presence information notifications from reaching the Watcher device.
